(19) United States
(12) Patent Application Publication
(10) Pub. No.: US 2026/0177164 A1
(43) Pub. Date: Jun. 25, 2026

(54) FLUID-CONTROLLED VALVE

(71) Applicant: KITZ SCT CORPORATION, Tokyo (JP)

(72) Inventor: Akira GOTO, Ohta-shi (JP)

(21) Appl. No.: 19/424,886

(22) Filed: Dec. 18, 2025

(30) Foreign Application Priority Data
Dec. 23, 2024 (JP) 2024-226111

(51) Int. Cl. F16K 31/122; F16K 7/17

(52) U.S. Cl. CPC F16K 31/1225; F16K 7/17

(57) ABSTRACT

An integrated compact fluid-controlled valve that exhibits a high sealing force to reliably prevent leakage and enables fluid having a high pressure to flow while suppressing deterioration of sealing performance. The integrated compact fluid-controlled valve includes separate pistons (23) arranged in a series state with respect to a valve seat (13) in a spring state via a plurality of springs (24) having different spring loads, and air inlets (25) formed in an actuator (11). The corresponding pistons are disposed so that compressed air from the corresponding air inlets or the spring forces of the corresponding springs cause the corresponding pistons to separately and independently ascend and descend in predetermined strokes Y1 and Y2 in the actuator, and the valve disk is disposed so as to be able to seal a flow path by different sealing forces depending on the descending states of the corresponding pistons.

### BACKGROUND OF THE INVENTION

### Field of the Invention

The present invention relates to a fluid-controlled valve. In particular, the present invention relates to an air-driven fluid-controlled valve including an actuator that pneumatically operates a piston to drive a valve disk to be opened and closed.

### Description of the Related Art

Conventionally, such a kind of an air-driven fluid-controlled valve has been used in, for example, a step of manufacturing a semiconductor, a step of manufacturing a panel, or the like, and commonly often disposed as an integrated valve equipped with an actuator for driving a valve disk. Examples of such fluid-controlled valves include a fluid-controlled valve having a structure in which a piston driving mechanism that drives a valve disk by compressed air is disposed in the interior of an actuator, and the driving mechanism is further equipped with a spring for driving a piston. The internal structure allows the piston to be driven by the elastic force of the spring in a direction opposite to the direction of driving the piston by pressure fluid, to control the valve disk to be opened and closed.

For example, a fluid-controlled valve described in Japanese Patent Laid-Open No. 2002-349747 is disclosed as an air-driven valve having such a structure. The fluid-controlled valve is equipped with an actuator that is referred to as a so-called normally-closed actuator, and is normally in a valve-closed state. Pistons mounted in the actuator are mounted in a cylinder through the elastic forces of springs.

In particular, the fluid-controlled valve has a structure in which large and small piston chambers having different inner diameters are partitioned by a partition wall, a large-diameter piston and a small-diameter piston are attached to the large and small piston chambers via the springs, and a valve disk is normally biased in a valve-closing direction from the plurality of large-diameter piston and the small-diameter piston through valve rods by the spring forces of the springs. As a result, intake and exhaust of pressure fluid from two ports into the cylinder equipped with each piston allow each piston to be driven and the two pistons to be simultaneously driven, to transmit a driving force from one valve rod to the valve disk against the spring biasing forces of the springs, to control the driving force in the valve-opening direction of the valve rod in a wide range, so that a valve disk side is opened and closed.

Such a fluid-controlled valve may be used to, for example, supply material gas (process gas) for a step of manufacturing a semiconductor to a process chamber. Examples of such fluid-controlled valves include a fluid-controlled valve disposed to be able to be used for supplying material gas to a process chamber, according to atomic layer deposition (ALD) or atomic layer etching (ALE) which is considered to become in the mainstream of a process of manufacturing a next-generation semiconductor in the near future. In particular, such a fluid-controlled valve may be used according to a process of supplying material gas to a process chamber, purge of the interior of the fluid-controlled valve or a pipe, or maintenance in an airtightness test or the like.

In such a case, in process, the time of the process is determined based on the speed of opening and closing of a valve disk, and therefore, the higher speed of opening and closing of the valve disk is demanded. In addition, the number of times of opening and closing of the valve disk per unit time is also increased, and therefore, a valve disk side and a valve seat also require improvement in durability.

In addition, it is also desired to supply material gas in a state in which the amount of the supplied material gas is stabilized while reducing a change in Cv value in a valve-opening state in process.

As described above, the security of functionalities such as the speed of opening and closing a valve, durability, and the stability of a Cv value is particularly demanded in a step requiring accuracy, such as ALD or ALE.

In contrast, it is necessary to reliably move the valve disk side to a closing position by the spring force of a spring, and to seal the valve disk side, even in a case in which the material gas is going to flow due to the working pressure of the material gas, in a valve-closed state in process.

As described above, the above-described functionalities different from those in purge or maintenance are demanded in process. Thus, a process, or purge or maintenance may be performed using a fluid circuit 1 illustrated in FIG. 5 instead of using such an integrated fluid-controlled valve, for adaptation to steps of ALD and ALE.

In FIG. 5, two valves which are a control valve 3 and a control valve 4 are disposed in the primary side of a process chamber 2. The control valve 3 is a valve that is opened and closed in process as described above. In the control valve 3, the flow rate in the case of opening the valve is low, and the stroke in the case of opening and closing a valve disk comprising a diaphragm is low. In the control valve 4, the flow rate in the case of opening the valve is higher than that in the control valve 3, and the stroke in the case of opening and closing the valve disk is higher than that in the control valve 3. A process side flow path 5 for supplying material gas in process and a supply flow path 6 for supplying pressure gas in purge or maintenance are connected to the primary side of the control valves 3 and 4 so that the process side flow path 5 and the supply flow path 6 are connected in parallel. Opening and closing valves 7 and 8 for opening and closing the flow paths are disposed in the process side flow path 5 and the supply flow path 6, respectively.

In the fluid circuit 1 described above, supply of predetermined material gas having a low flow rate can be performed or stopped to control the flow rate of the material gas by allowing the opening and closing valve 7 of the process side flow path 5 to be in an open state and the opening and closing valve 8 of the supply flow path 6 to be in a closed state in process, and opening and closing the control valve 3 while keeping the control valve 4 in an open state in a state in which the material gas can be supplied from the process side flow path 5.

In contrast, supply of pressure gas of which the flow rate is higher than that in process can be performed or stopped to perform purge, maintenance, and the like by opening and closing the control valve 4 while keeping the control valve 3 in an open state in a state in which the opening and closing valve 8 of the supply flow path 6 is allowed to be in an open state, and the opening and closing valve 7 of the process side flow path 5 is allowed to be in a closed state to enable pressure gas to be supplied from the supply flow path 6 in purge or maintenance.

As described above, the two valves which are the control valve 3 and the control valve 4 are used in the fluid circuit 1 in FIG. 5. In addition to the control valves 3 and 4, the two opening and closing valves 7 and 8 for opening and closing a flow path are used in the fluid circuit 1. The fluid circuit 1 is configured to control fluid in process, purge, or maintenance by using the plurality of valves described above.

In such a case, material gas using a material having a low vapor pressure, such as a solid material, is often supplied in process of the material gas into the process chamber 2. In such a case, a pressure generated in a valve is a comparatively low pressure of, for example, 0.1 MPaG or less. In contrast, in purge or maintenance in a pipe, pressure gas is often supplied so that the pressure of the pressure gas is higher than that of the material gas in process. The maximum allowable working pressure generated in the valve in such a case is, for example, 0.2 MPaG, or optionally 0.7 MPaG or more.

### BRIEF SUMMARY OF THE INVENTION

In the case of using the integrated fluid-controlled valve described above as a valve for controlling fluid to a process chamber with adaptation to ALD and ALE, it is necessary to design an actuator so that the maximum allowable working pressure of pressure gas in purge or maintenance can also be sealed. In such a case, in a normally-closed fluid-controlled valve, it is necessary to set the spring force of a spring that seals a valve disk at a high value to increase a sealing force in order to enhance maximum allowable working pressure in the case of closing the valve.

However, the case of increasing the spring force of the spring results in an increase in load (pressing force) toward the valve disk and a valve seat, to also increase a force required for moving the valve disk in an open direction, and therefore causes a problem that a load on compressed air is increased to increase the thrust of an actuator, and the working speed of a piston in a valve-opening direction is decreased. Such a case may be unsuitable for use as a valve for a step of ALD or ALE requiring the high-speed operation of the valve disk.

In addition, an increase in the spring force of a spring is prone to result in the surface roughness, crushing, or the like of a valve disk or a valve seat due to a repeated operation of opening and closing a valve disk. In particular, a valve seat including a resin material such as, for example, a fluorine resin such as PFA excellent in heat resistance and chemical resistance is often disposed in a valve in the field of manufacturing a semiconductor. In this case, the hardness of the valve seat is lower than that of a valve seat made of a metal, and therefore, the valve seat is prone to be deformed or broken. The deformation or breakage of the valve seat also results in an increase in stress applied to a diaphragm closer to the valve disk, also leading to the deterioration of durability.

The deformation or breakage of the valve seat may result in a problem that, in the case of opening valves, a gap between the valves is enlarged, sealing performance in the case of closing the valves is deteriorated due to the gap, and a Cv value in the case of opening the valves is changed to deteriorate the stability of the flow rate.

As described above, in the case of increasing the spring force of a spring in order to seal the maximum allowable working pressure of pressure gas in purge or maintenance, the opening and closing speed of a valve disk is decreased, and the sealing performance and durability of a valve disk side and a valve seat side are deteriorated in process, whereby the stability of a Cv value is also deteriorated.

Furthermore, an increase in the volume of the interior of a cylinder to increase the amount of compressed air used is required for reliably opening a valve against the spring force of a spring, necessary for closing the valve.

In contrast, it is possible that in the fluid-controlled valve according to Japanese Patent Laid-Open No. 2002-349747, separate or simultaneous driving of two pistons allows one valve rod to be moved up and down, and the driving magnitude of force (range of upward and downward movement) to be increased, to control the flow rate in opening of a valve disk in a wide range, pressure fluid is supplied only to one piston side to allow the valve disk to be in the state of a slight opening degree, and pressure fluid is supplied to both piston sides to increase the flow rate in a full open state.

However, this valve has a structure in which a coil spring that resiliently applying a bias in a fully closed direction is allowed to act on one valve rod, and therefore, the resultant force of the spring biasing forces of a plurality of coil springs is applied toward a valve seat in full closing. Thus, like the case described above, the strong spring forces of the coil springs in closing of the valve causes various problems. Therefore, stability in process may be deteriorated in a case in which the valve is used for a step of ALD or ALE.

In contrast, in FIG. 5, the total number of valves used is greatly increased because not only the number of the valves is increased due to the two control valves 3 and 4 but also the two opening and closing valves 7 and 8 for opening and closing a flow path are needed in the case of using the two control valves 3 and 4 as fluid-controlled valves to perform, process, or purge or maintenance. In addition, there are also problems that the process side flow path 5 and the supply flow path 6 for connecting the four valves are added, and the whole fluid circuit 1 is complicated for controlling the operation of each valve. Thus, the fluid circuit 1 in FIG. 5 is larger than an integrated fluid-controlled valve, and is therefore poor in compactness. In the fluid circuit 1, control of a flow path is also complicated, whereby an integration property into an integrated semiconductor manufacturing system or a panel manufacturing system is also deteriorated.

Based on the above, it has been desired to develop a compact fluid-controlled valve that can be adapted to a state in which the working pressure of material gas in process is low and a state in which the maximum allowable working pressure of pressure gas in purge or maintenance is high even in the case of requiring highly accurate control in ALD, ALE or the like, and that is operated in an adequate state under any circumstance even in a case in which the pressure of fluid flowing into the valve varies.

The present invention was developed to solve the conventional problems, and has an objective of providing an integrated compact fluid-controlled valve that enables a flow path to be opened and closed in response to different fluid pressures, allows a valve disk to be opened and closed at a high speed to control fluid having a low pressure with high accuracy in the case of allowing the fluid to flow, exhibits a high sealing force in closing of the valve to reliably prevent leakage and enables fluid having a high pressure to flow while suppressing the deterioration of sealing performance to improving durability and to prevent the change of the flow rate at a stable Cv value even in the case of allowing the fluid to flow, and enables the amount of consumed compressed air for driving to be also reduced.

In order to achieve the objective described above, the invention according to claim 1 is a fluid-controlled valve, wherein pistons are mounted in an actuator via springs, the pistons allow a valve disk to contact with and separate from a valve seat to open and close a flow path by compressed air from air inlets or spring forces of the springs, the pistons are separately formed as a plurality of piston members, the separate pistons are arranged in a series state with respect to the valve seat in a spring state via the plurality of springs having different spring loads, the corresponding air inlets through which the compressed air that operates the corresponding separate pistons in directions opposite to spring directions of the springs is supplied are formed in the actuator, the corresponding separate pistons are disposed so that the compressed air from the corresponding air inlets or the spring forces of the corresponding springs cause the pistons to separately and independently ascend and descend in the predetermined strokes in the actuator, and the valve disk is disposed so as to be able to seal the flow path by different sealing forces depending on descending states of the corresponding separate pistons formed as the plurality of piston members.

The invention according to claim 2 is the fluid-controlled valve, wherein the corresponding separate pistons include a first piston arranged in a primary side at a position in a vicinity of the valve disk and a second piston disposed in a secondary side closer to the valve disk than the first piston, the first piston and the second piston are disposed so as to be able to simultaneously ascend and descend, or the first piston is disposed so as to be able to ascend and descend in a state in which the second piston ascends.

The invention according to claim 3 is the fluid-controlled valve, wherein a first spring is mounted in an area closer to the first piston, a second spring is mounted in an area closer to the second piston, and a spring load of the second spring is set to be greater than a spring load of the first spring.

The invention according to claim 4 is the fluid-controlled valve, wherein the spring load of the first spring is set at a magnitude for sealing material gas for a semiconductor manufacturing step, supplied into the flow path in a case in which the valve disk is pressed against the valve seat via the first piston in a state in which the second piston ascends.

The invention according to claim 5 is the fluid-controlled valve, wherein a sum of the spring loads of the first spring and the second spring is set at a magnitude for sealing pressure gas for purge or maintenance, supplied into the flow path in a case in which the valve disk is pressed against the valve seat via the first piston and the second piston.

The invention according to claim 6 is the fluid-controlled valve, wherein the corresponding springs are mounted in a spring state in a direction in which the corresponding separate pistons are allowed to descend to close the valve disk, and the corresponding air inlets are formed in the actuator so that compressed air can be supplied in a direction in which the corresponding separate pistons are allowed to ascend to open the valve disk.

The invention according to claim 7 is the fluid-controlled valve, wherein a gap is disposed between facing surfaces of the second piston and the first piston that ascends in a case in which the first piston ascends and descends in a state in which the second piston ascends.

In accordance with the invention according to claim 1, the pistons are separately formed as a plurality of piston members, the separate pistons are arranged in a series state with respect to the valve seat in a spring state via the plurality of springs having different spring loads, the corresponding air inlets through which the compressed air that operates the corresponding pistons in directions opposite to spring directions of the springs is supplied are formed in the actuator, the corresponding pistons are disposed so that the compressed air from the corresponding air inlets or the spring forces of the corresponding springs cause the pistons to separately and independently ascend and descend in the predetermined strokes in the actuator, and the valve disk is disposed so as to be able to seal the flow path by different sealing forces depending on descending states of the corresponding pistons. Therefore, the flow path can be opened and closed in response to different fluid pressure. As a result, adaptation to fluid having a very low pressure and fluid having an extremely high pressure is enabled. In the case of allowing fluid having a low pressure such as a working pressure of 0.1 MPaG to flow, operation of only the separate piston closer to the valve disk enables the valve disk to be opened and closed at a higher speed and fluid to flow while controlling the fluid with higher accuracy than those in the case of operating all the pistons. Even in the case of allowing pressure gas having an extremely high pressure such as a maximum allowable working pressure of 0.7 MPaG to internally flow, a higher sealing force can be applied to the separate pistons and the plurality of springs to reliably prevent leakage in closing of the valve. Since the thrust of the pistons can be reduced, stress generated in the valve disk and the valve seat can be reduced to prevent the deterioration of sealing performance to improve durability, the deformation amounts of the valve disk and the valve seat can be reduced to enable fluid to flow with highly accurate fluid control while preventing the change of the flow rate at a stable Cv value, and the amount of consumed compressed air for driving can also be reduced.

Based on the above, the fluid-controlled valve is particularly suitable for a step in which the amount of supplied material gas is controlled by controlling opening and closing of the valve disk at a high speed and the control of fluid at a slightly low flow rate is demanded, such as ALD or ALE, and can be placed while contributing to improvement in tact in a manufacturing line or the like, and the stability of a process. In such a case, an increase in the flow rate of material gas and a decrease in the vapor pressure of the material gas allows a load on the valve seat and the valve disk to be reduced to also improve thermal resistance even in the case of heating the fluid-controlled valve, including a pipe and the like, to high temperature in each step such as ALD or ALE.

Since the fluid-controlled valve is integrated, the fluid-controlled valve can be allowed to be compact. Thus, the fluid-controlled valve is easily placed in each location with a narrow footprint in various semiconductor manufacturing steps and panel manufacturing steps.

In accordance with the invention according to claim 2, the corresponding separate pistons include the first piston and the second piston, and the pistons are disposed so as to be able to simultaneously ascend and descend. Therefore, a flow path through which high-pressure fluid flows is secured to allow the fluid to smoothly flow in the case of opening the valve via the two pistons in the case of allowing fluid having a high maximum allowable working pressure to internally flow in purge, maintenance, or the like, and pressure gas is reliably sealed at a high thrust caused by the resultant force of the two pistons to prevent internal leakage in the case of closing the valve. The first piston is disposed so as to be able to ascend and descend in a state in which the second piston ascends. Therefore, in a case in which fluid having a low working pressure is allowed to internally flow, the valve disk can be opened and closed at a high speed in the lower stroke than that in the case of allowing the first and second pistons to simultaneously ascend and descend, and the flow rate of the fluid having a low working pressure can be controlled with high accuracy.

In accordance with the invention according to claim 3, the spring load of the second spring is set to be greater than the spring load of the first spring. Therefore, in the case of allowing fluid having a low working pressure to internally flow, a state in which a load is decreased by the first spring is achieved, and compressed air can be smoothly supplied. As a result, only the first piston can be opened and closed by the compressed air, and the flow rate of the fluid having a low working pressure can be controlled with high accuracy and at a high speed.

In accordance with the invention according to claim 4, the spring load of the first spring is set at a magnitude for sealing material gas for a semiconductor manufacturing step, supplied into the flow path in a case in which the valve disk is pressed against the valve seat via the first piston in a state in which the second piston ascends. Therefore, in the case of allowing material gas having a low working pressure to internally flow in process such as ALD or ALE, the flow rate of the material gas can be controlled with high accuracy, and the material gas can be allowed to flow into a flow path in a process chamber or the like.

In accordance with the invention according to claim 5, the sum of the spring loads of the first spring and the second spring is set at a magnitude for sealing pressure gas for purge or maintenance, supplied into the flow path in a case in which the valve disk is pressed against the valve seat via the first piston and the second piston. Therefore, in the case of allowing pressure gas having a high pressure to internally flow in purge or maintenance in ALD, ALE, or the like, a valve open state can be achieved in a state in which the high flow rate is secured. In contrast, high sealing performance is exhibited to reliably seal the pressure gas in closing of the valve.

In accordance with the invention according to claim 6, the corresponding springs are mounted in a spring state in a direction in which the corresponding separate pistons are allowed to descend to close the valve disk, and the corresponding air inlets are formed in the actuator so that compressed air can be supplied in a direction in which the corresponding separate pistons are allowed to ascend to open the valve disk. Therefore, the fluid-controlled valve can be formed as an integrated valve equipped with a normally-closed actuator, a valve-closed state can be maintained in a normal case, and the compressed air can be supplied to maintain a valve open state in control of fluid.

In accordance with the invention according to claim 7, a gap is disposed between the facing surfaces of the second piston and the first piston that ascends in a case in which the first piston ascends and descends in a state in which the second piston ascends. Therefore, in a case in which the first piston ascends in a state in which the second piston ascends, the facing surfaces of the pistons are prevented from coming into contact with each other, and shock in control of fluid, and the deformation or breakage of the first and second pistons can be prevented.

### BRIEF DESCRIPTION OF THE DRAWINGS

FIG. 1 is a longitudinal cross-sectional view illustrating the fully closed state of an embodiment of a fluid-controlled valve according to the present invention;

FIG. 2 is a longitudinal cross-sectional view illustrating the full open state of the fluid-controlled valve in FIG. 1;

FIG. 3 is a cross-sectional view illustrating a state in which only the first piston ascends from the fluid-controlled valve in FIG. 2;

FIG. 4 is a schematic view illustrating the opening and closing state of the valve disk of the fluid-controlled valve of an embodiment of the present invention; and

FIG. 5 is a schematic view illustrating a fluid circuit for controlling fluid, using a plurality of control valves.

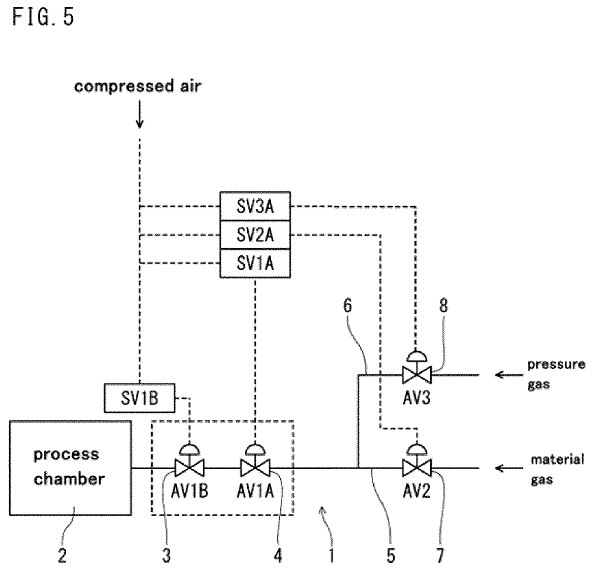

### DETAILED DESCRIPTION OF THE INVENTION

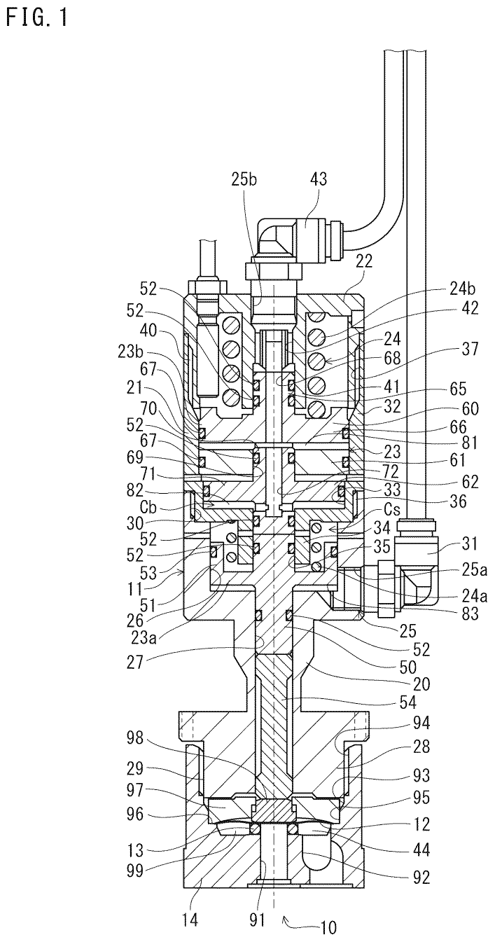

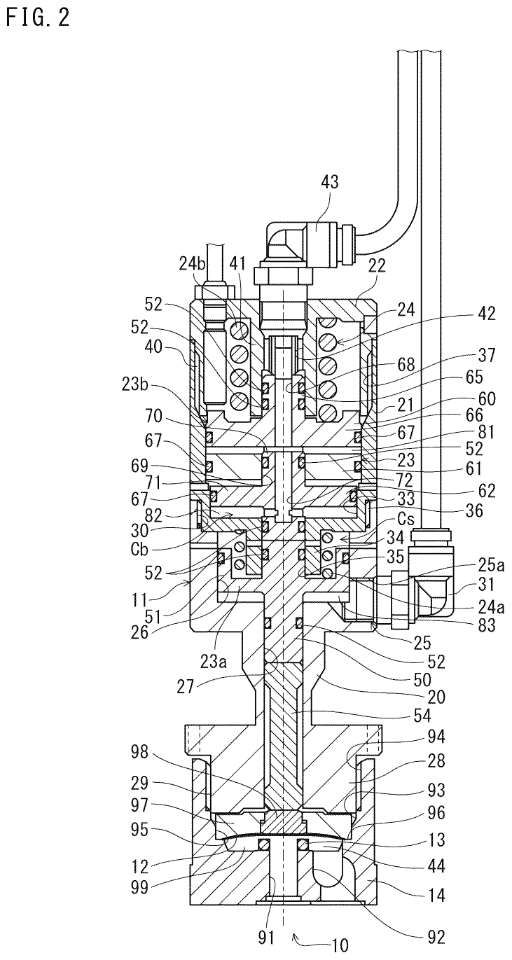

Embodiments of a fluid-controlled valve according to the present invention are described in detail below with reference to the drawings. FIG. 1 illustrates the fully closed state of the fluid-controlled valve according to the present invention, and FIG. 2 illustrates the full open state of the fluid-controlled valve in FIG. 1.

The fluid-controlled valve 10 in the present embodiment is used as, for example, a valve that is connected to the primary side of a process chamber (not illustrated) in an apparatus for manufacturing a semiconductor, and corresponds to ALD or ALE, and internally flowing pressure fluid is controlled by opening and closing the fluid-controlled valve 10. Examples of the pressure fluid include pressure gas for purge or maintenance, and material gas for a step of manufacturing a semiconductor. The pressure of the pressure gas is higher than that of the material gas. For example, high-pressure compressed air is used as the pressure gas. The fluid-controlled valve 10 is disposed so that the flow rate of the material gas is controlled through the fluid-controlled valve 10, and the material gas can be supplied to the process chamber.

In FIG. 1, the fluid-controlled valve 10 in the present embodiment includes: an actuator 11; a valve disk 12 comprising a diaphragm; a valve seat (seat) 13; and a body 14. The fluid-controlled valve 10 is disposed so that the height (full-length) of the fluid-controlled valve 10 is, for example, 5 inches or less.

First, the actuator 11 in the fluid-controlled valve 10 is described. The actuator 11 includes a base 20, a case 21, a cover 22, pistons 23, and springs 24, and is disposed in the upper area of the fluid-controlled valve 10. The actuator 11 is disposed so as to have, for example, a diameter p of 38 mm or less, which is an outer diameter. Air inlets 25 for supplying compressed air are disposed in the actuator 11. The air inlets 25 include a first air inlet 25a and a second air inlet 25b.

The base 20 is formed to have a roughly cylindrical shape of which the vicinity of the center is formed in a reduced-diameter shape with, for example, a stainless material. A concave hole 26 allowed to have a bottom by an inner diameter in which a small cylinder chamber Cs described later can be formed is disposed in a cylindrical site having an increased-diameter shape in the upper area of the base 20. The base 20 is perforated with a through-hole 27, of which the diameter is smaller than that of the concave hole 26, up to the lower end of the base 20, following the concave hole 26. A connection 28 which is a connection side to the body 14 is disposed in the lower portion of the base 20 so that the diameter of the connection 28 is larger than that of the central portion of the base 20. A male thread portion 29 is formed on the outer periphery of the lower end side of the connection 28. The inner diameter of the opening side of the upper end of the base 20 is formed to be larger than the inner diameter of the concave hole 26, and a female thread 30 is formed on the inner periphery thereof.

The first air inlet 25a is formed in the vicinity of the bottom surface side of the concave hole 26 so as to communicate with the concave hole 26. A first air flow path 31 which is external is connected to the first air inlet 25a, and compressed air which is supplied through the first air flow path 31 can be supplied to the small cylinder chamber Cs through the first air inlet 25a.

The case 21 is formed of, for example, aluminum alloy to have a roughly cylindrical shape, and a cylindrical portion 32 is disposed the upper area thereof. A concave hole 33 of which the inner diameter (volume) is slightly larger than that of the small cylinder chamber Cs described above is disposed in the cylindrical portion 32. The concave hole 33 allows a large cylinder chamber Cb to be configurably disposed. The large cylinder chamber Cb is disposed to have a larger volume than the volume of the small cylinder chamber Cs. The large cylinder chamber Cb is disposed so that a thrust in a case in which compressed air is supplied from the second air inlet 25b to the large cylinder chamber Cb to operate a second piston 23b described later is greater than a thrust in a case in which compressed air is supplied from the first air inlet 25a to the small cylinder chamber Cs to operate a first piston 23a described later.

In the lower portion of the cylindrical portion 32, a cylindrical projection 34 is formed to have a diameter that is smaller than the outer diameter of the cylindrical portion 32. In the center of the cylindrical projection 34, a communication hole 35 is formed to have an inner diameter that is generally equal to the inner diameter of the through-hole 27. A male thread 36 that can threadedly engage with the female thread 30 of the base 20 is formed in an area upper than the cylindrical projection 34. The opening side of the upper end of the cylindrical portion 32 is disposed to have a diameter that is larger than the inner diameter of the concave hole 33, and a female thread portion 37 is formed on the inner peripheral side thereof.

The cover 22 is formed of, for example, aluminum alloy to have a cylindrical shape enabling the opening side of the upper end of the case 21 to be covered, and a male thread portion 40 that can threadedly engage with the female thread portion 37 of the case 21 is formed in the outer peripheral side of the lower portion thereof. A protrusion cylinder 41 having a cylindrical shape is formed in the center of the inside of the cover 22, and an insertion hole 42 is formed in the inside of the protrusion cylinder 41. The second air inlet 25b is formed in the upper opening side of the insertion hole 42. A second air flow path 43 which is external is connected to the second air inlet 25b by threaded engagement so that compressed air supplied through the second air flow path 43 can be supplied from the second air inlet 25b into the large cylinder chamber Cb through the insertion hole 42.

The base 20 and case 21 described above are fixed to each other by threadedly engaging the female thread 30 and the male thread 36 with each other, the case 21 and the cover 22 are fixed to each other by threadedly engaging the female thread portion 37 and the male thread portion 40 with each other, and the base 20, the case 21, and the cover 22 are integrally connected in a roughly cylindrical shape. Therein, each of the pistons 23, the springs 24, and the like is accommodated to form the actuator 11.

In such a case, the pistons 23 are mounted in the actuator 11 via the springs 24, and the fluid-controlled valve 10 is disposed so that the pistons 23 allow the valve disk (diaphragm) 11 to contact with and separate from the valve seat 13 by compressed air from the air inlets 25, or the spring forces of the springs 24 by automatic operation of the actuator 11, and opening and closing of a flow path 44 disposed in the body 14 can be controlled.

The pistons 23 are separately formed as a plurality of piston members of, for example, aluminum alloy as a material, and the corresponding separate pistons 23 are arranged in a series state with respect to the valve seat 13 in a spring state via the plurality of springs 24 having different spring loads. The series state is a state in which as illustrated in FIG. 1 and the like, the corresponding pistons 23 are arranged in a single row on the same axis, and longitudinally arranged in a straight line, and the transmission force of one of the corresponding pistons 23 is easily transmitted to the other piston 23 by direct contact.

In addition, the first air inlet 25a and the second air inlet 25b are formed in the actuator 11 so that compressed air that operates the corresponding separate pistons 23 in directions opposite to the spring directions of the corresponding springs 24 can be supplied through the first air inlet 25a and the second air inlet 25b. The spring state of each spring in the present embodiment refers to a state in which the spring is pressed by applying a spring load to the spring, and the spring in itself is deformed while storing a pressing force. Obtainment of such a spring property (which may be expressed as elasticity in another word) allows, for example, the fluid-controlled valve 10 to be subjected to closely contact seal (valve-closed state) by allowing the pistons 23 to allow compressed air from the air inlets 25 to allow the pistons 23 to descend while deforming the corresponding springs 24 to press down the valve disk (diaphragm) 11 against the valve seat 13 by the automatic operation of the actuator 11. In the case of the valve-closed state, the spring state of each spring is maintained. In the case of achieving a valve open state, exhaustion of the compressed air allows the pressing force stored by each spring in itself to be released, the deformation of each spring to be recovered, the pistons 23 to ascend, the valve disk (diaphragm) 11 to separate from the valve seat 13, and the valve open state to be achieved. In the case of the valve open state, the spring state of each spring is canceled. These actions allow the flow path 44 disposed in the body 14 to be disposed to control opening and closing of the flow path 44.

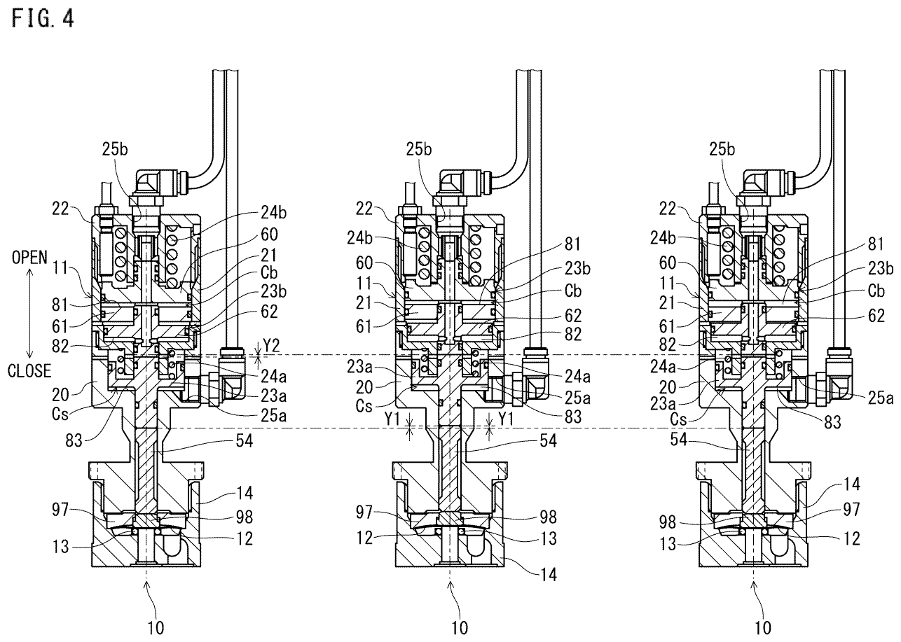

The fluid-controlled valve 10 is disposed so that the corresponding separate pistons 23 separately and independently ascend and descend in the predetermined strokes Y1 and Y2 in the actuator 11 by the compressed air from the first and second air inlets 25a and 25b, or the spring forces of the corresponding springs 24, as illustrated in FIG. 4. The diaphragm 12 is disposed so that the flow path 44 can be sealed by different sealing forces depending on the state of movement (state of descending) of the plurality of separate pistons 23 in the direction of the valve seat 13.

In FIGS. 1 to 3, the pistons 23 include the first piston 23a and the second piston 23b, the first piston 23a is arranged in the primary side which is at a position in the vicinity of the diaphragm 12, and the second piston 23b is disposed on the secondary side with respect to the diaphragm 12, farther from the diaphragm 12 than the first piston 23a. The first piston 23a and the second piston 23b are disposed so as to be able to simultaneously ascend and descend as described later, or disposed so that only the first piston 23a can ascend and descend in a state in which the second piston 23b remains in the ascended position. The first piston 23a is mounted so as to be able to exhibit a pressure resistance performance (seal performance) of 0.1 MPa or more, and the second piston 23b is mounted so as to be able to exhibit a pressure resistance performance (seal performance) of 1 MPa or more.

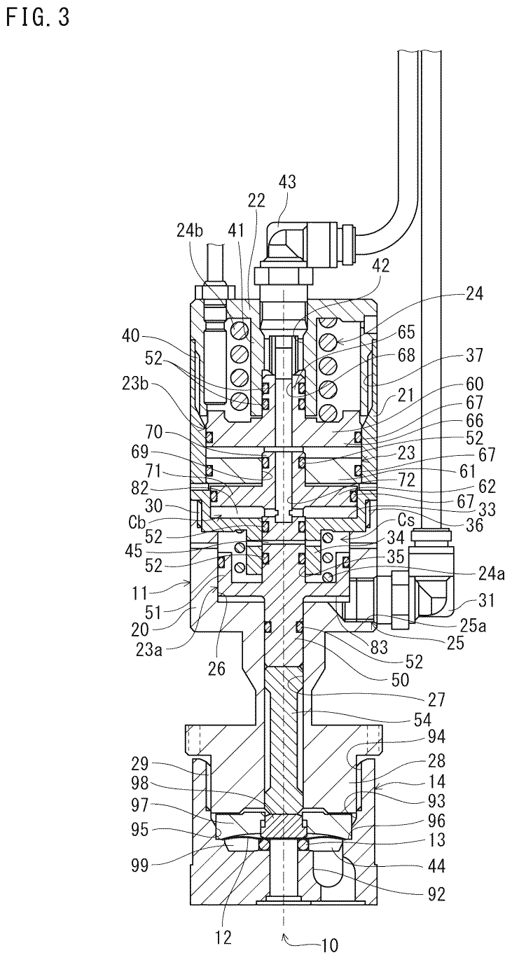

A gap 45 is configured to be disposed between the facing surfaces of the shaft 70, described later, of the second piston 23b in an ascending state and the shaft 50, described later, of the first piston 23a ascending and descending with respect to the second piston 23b, as illustrated in FIG. 3, in a case in which the second piston 23b ascends.

The first piston 23a includes the shaft 50 having a columnar shape and a cylindrically-shaped expanding-diameter cylindrical portion 51 having a one-side opening shape (upper opening shape) formed on the outer periphery in the vicinity of the center of the shaft 50. The shaft 50 is disposed so that the lower side of the shaft 50 is inserted into the through-hole 27, the upper side of the shaft 50 is inserted into the communication hole 35, and the shaft 50 can slide in an upward-downward direction. In such an insertion state, the first piston 23a is arranged in the small cylinder chamber Cs disposed between the base 20 and the case 21. The expanding-diameter cylindrical portion 51 is formed to have an outer diameter generally equal to the inner diameter of the small cylinder chamber Cs. O-rings 52 and 53 for sealing are mounted in two places on the outer peripheries of the upper and lower sides of the shaft 50, and one place on the outer periphery of the expanding-diameter cylindrical portion 51, respectively.

Sealing between the through-hole 27 and the outer peripheral surface of the lower portion of the shaft 50 is achieved by the O-ring 52 in the lower side of the shaft 50, sealing between the communication hole 35 and the outer peripheral surface of the upper portion of the shaft 50 is achieved by the O-ring 52 in the upper side of the shaft 50, and sealing between the outer peripheral surface of the expanding-diameter cylindrical portion 51 and the inner peripheral surface of the concave hole 26 is achieved by the O-ring 53 of the expanding-diameter cylindrical portion 51.

In such a manner, the first piston 23a is disposed so that the first piston 23a can ascend and descend while configuring the small cylinder chamber Cs in a state in which the sliding surface of the outer peripheral side of the first piston 23a is sealed.

In the through-hole 27, a rod 54 having a generally columnar shape is mounted in a state in which the rod 54 abuts on the lower portion of the shaft 50 of the first piston 23a. The rod 54 is disposed so as to ascend and descend in the through-hole 27 while ascending and descending the first piston 23a.

The second piston 23b includes three pistons of an upper piston 60 arranged in the upper position, a middle piston 61 arranged in the middle position, and a lower piston 62 arranged in the lower position in the case 21 (in the large cylinder chamber Cb).

The upper piston 60 is disposed in a shape including a shaft 65 having a cylindrical shape and a disk portion 66 having an expanding-diameter shape formed in the lower side of the shaft 65. The O-rings 52 for sealing are mounted in the two places in the outer periphery of the shaft 65, and the shaft 65 is inserted into the insertion hole 42 so as to be able to slide upward and downward in a sealing state, and the upper piston 60 is arranged so as to be able to ascend and descend in the large cylinder chamber Cb.

The disk portion 66 is formed to have an outer diameter that is generally equal to the inner diameter of the large cylinder chamber Cb. An O-ring 67 for sealing is attached to the outer periphery of the disk portion 66, sealing between the disk portion 66 and the inner peripheral surface of the concave hole 33 is achieved by the O-ring 67, and the upper piston 60 is mounted in a sealing state in the large cylinder chamber Cb.

A penetrating flow path 68 is formed in the shaft 65 of the upper piston 60. The penetrating flow path 68 is disposed in the large cylinder chamber Cb in an aspect in which compressed air can be supplied from the upper surface side of the shaft 65 to the bottom surface side of the disk portion 66. The penetrating flow path 68 is disposed so that the compressed air supplied through the second air inlet 25b can be supplied toward the middle piston 61 and the lower portion piston 62 through the penetrating flow path 68.

The middle piston 61 is formed to have a discoid shape, and to have an outer diameter that is generally equal to the inner diameter of the large cylinder chamber Cb. The O-ring 67 for sealing is attached to the outer periphery of the middle piston 61. Sealing between the middle piston 61 and the inner peripheral surface of the concave hole 33 is achieved by the O-ring 67. An insertion hole 69 is formed in the center of the middle piston 61. The middle piston 61 is mounted so that the upper side of the shaft 70 of the lower piston 62 described later can slide upward and downward in the insertion hole 69, and is arranged between the upper piston 60 and the lower piston 62.

The lower piston 62 is disposed to have a shape including the shaft 70 having a generally cylindrical shape and a disk portion 71 with an expanding-diameter shape, formed in the central side of the shaft 70. In the shaft 70, the O-ring 52 for sealing is mounted on the outer periphery of the upper side of the shaft 70. The shaft 70 is inserted in a seal state into the insertion hole 69 of the middle piston 61 in a state in which the shaft 70 can slide upward and downward. The shaft 70 is disposed so that the middle piston 61 and the lower piston 62 can relatively move. The O-ring 52 for sealing is mounted on the outer periphery of the lower side of the shaft 70, and is inserted in a seal state into the communication hole 35 in a state in which the O-ring 52 can slide upward and downward. The lower piston 62 is arranged in the large cylinder chamber Cb so that the lower piston 62 can ascend and descend.

A penetrating flow path 72 is disposed in the shaft 70 of the lower piston 62. The penetrating flow path 72 is disposed in the large cylinder chamber Cb in an aspect in which compressed air can be supplied from the upper surface side of the shaft 70 to the bottom surface side of the disk portion 71.

The second piston 23b is disposed so that the upper piston 60, middle piston 61, and lower piston 62 described above can each independently ascend and descend in the large cylinder chamber Cb in a state in which the upper piston 60, the middle piston 61, and the lower piston 62 are combined. In such a case, the upper surface of the shaft 70 of the lower piston 62 always abuts on the bottom surface of the disk portion 66 of the upper piston 60, and the middle piston 61 is integrated between the upper piston 60 and the lower piston 62 in a state in which the middle piston 61 can relatively move. Such a structure allows the second piston 23b to enable the upper and lower pistons 60 and 62 to ascend and descend in the cylindrical portion 32.

The springs 24 include a first spring 24a and a second spring 24b, which are formed as coil springs. The springs 24a and 24b are disposed through the coil springs, respectively. The spring load of the second spring 24b is set to be greater than the spring load of the first spring 24a. In other words, the spring force of the second spring 24b is greater than the spring force of the first spring 24a.

The first spring 24a is mounted between the bottom surface side of the inner periphery of the expanding-diameter cylindrical portion 51 of the first piston 23a and the bottom surface of the cylindrical portion 32 of the case 21 in an area closer to the first piston 23a described above. The first piston 23a is biased against the base 20 in a downward direction by the spring force of the first spring 24a.

The second spring 24b is mounted between the upper surface side of the disk portion 66 of the upper piston 60 in the second piston 23b and the inner facing surface of the cover 22 in an area closer to the second piston 23b described above. The upper piston 60 is biased in a downward direction by the spring force of the second spring 24b. The lower piston 62 and the middle piston 61, integral with the upper piston 60, are biased against the case 21 in a downward direction.

In such a case, as described above, the spring load of the second spring 24b is allowed to be greater than the spring load of the first spring 24a, whereby the pressure of compressed air necessary for allowing the second piston 23b to ascend against the spring force of the second spring 24b is allowed to be greater than the pressure of compressed air necessary for allowing the first piston 23a to ascend against the spring force of the first spring 24a. As a result, the first piston 23a can be allowed to ascend and descend by a smaller force with respect to the second piston 23b.

The spring load of the first spring 24a is set at a magnitude for sealing process gas (material gas) supplied into the flow path 44 of the body 14 in the case of pressing the diaphragm 12 against the valve seat 13 via the first piston 23a in a state in which the second piston 23b remain in the ascended positions.

The sum of the spring loads of the first spring 24a and the second spring 24b is set at a magnitude for sealing pressure gas supplied into the flow path 44 in the case of pressing the diaphragm 12 against the valve seat 13 via the first piston 23a and the second piston 23b.

The case 21 and the base 20 are joined by threaded engagement, to integrally form the actuator 11, in a state in which each of the second piston 23b and the second spring 24b is mounted in the case 21, and each of the first piston 23a and the first spring 24a is mounted in the base 20, as described above.

After the installation of the actuator 11, the first air chamber 81 and the second air chamber 82 are disposed between the upper piston 60 of the second piston 23b and the middle piston 61 and between the lower piston 62 and the bottom surface of the concave hole 33, respectively, in the large cylinder chamber Cb, so that compressed air from the second air inlet 25b can be supplied into each of the first and second air chambers 81 and 82.

In the small cylinder chamber Cs, a third air chamber 83 is disposed between the expanding-diameter cylindrical portion 51 of the first piston 23a and the bottom surface of the concave hole 26, so that compressed air from the first air inlet 25a can be supplied into the third air chamber 83.

As described above, the first second springs 24a and 24b are mounted in a spring state in the actuator 11 described above in the direction of allowing the first second pistons 23a and 23b which are separate to descend to close the diaphragm 12, and the first and second air inlets 25a and 25b are formed in the actuator 11 in the direction of allowing each of the pistons 23a and 23b to ascend to opening the diaphragm 12 so that compressed air can be supplied. As a result, in the fluid-controlled valve 10, the first and second pistons 23a and 23b are pressed to descend to allow the diaphragm 12 to be in a valve-closed state by the spring biasing forces of the first and second springs 24a and 24b in a normal state (in a natural state). In a case in which compressed air is supplied from the first and second air inlets 25a and 25b, the first and second pistons 23a and 23b ascend against the spring forces of the first and second springs 24a and 24b, respectively, and the elastic force of the diaphragm 12 allows the diaphragm 12 to self-recover in a valve-opening direction and to be in a valve open state. As described above, the actuator 11 of the fluid-controlled valve 10 of the present embodiment is formed as, so-called, a normally-closed type actuator.

Then, the body 14 of the fluid-controlled valve 10 is described. The body 14 is formed to have a roughly cylindrical shape of which the diameter is generally equal to that of the actuator 11. As a result, the whole fluid-controlled valve 10 is disposed to have a roughly cylindrical shape having a small diameter, whereby a footprint in the case of using the body in, for example, an apparatus for manufacturing a semiconductor is reduced.

In the body 14, a primary-side flow path 91 and a secondary-side flow path 92 are disposed to be able to communicate with external flow paths, respectively. An attaching recess 93 is formed to open in the upper sides of the primary-side flow path 91 and the secondary-side flow path 92. A female thread portion 94 with which the male thread portion 29 of the base 20 can threadedly engage is formed in the inner peripheral side of the upper portion of the attaching recess 93, and a ring-shaped attaching portion 96 having a stage 95 is formed in the lower side of the female thread portion 94. The diaphragm 12 and a bonnet 97 formed to have a ring shape are disposed on the attaching portion 96 so that the diaphragm 12 and the bonnet 97 can be attached in the state of mating with each other. A diaphragm piece 98 formed to have a generally columnar shape is attached to the bonnet 97. The valve seat 13 having a seat shape is attached to the opening side of the primary-side flow path 91 in the attaching recess 93, a valve chamber 99 is disposed between the valve seat 13 and the diaphragm 12, and the primary-side flow path 91 and the secondary-side flow path 92 are disposed so that the diaphragm 12 contacts with and separates from the valve seat 13 to enable the primary-side flow path 91 and the secondary-side flow path 92 to be opened and closed.

The diaphragm 12 is formed by overlapping metal materials (for example, Spron) which are generally disk-shaped thin sheets. In a natural state, the diaphragm 12 is disposed to have a disk shape which is a gently convex surface shape of which the center is regarded as a vertex toward one side (upper portion), as illustrated in FIG. 2. The shape allows the diaphragm 12 to have an elastic force enabling the diaphragm 12 to self-recover. The diaphragm 12 is attached to the attaching portion 96 in the state of being arranged on the upper side of the valve seat 13.

The bonnet 97 is formed to have a cylindrical shape, and is attached to the upper side of the diaphragm 12 in the attaching portion 96. The diaphragm piece 98 is inserted into the center of the bonnet 97 in a state in which the diaphragm piece 98 can slide in an upward-downward direction. The rod 54 described above is arranged on the upper side of the diaphragm piece 98, to integrate the actuator 11 and the body 14. Then, ascending and descending of the first piston 23a allows the diaphragm piece 98 to be disposed on the bonnet 97 via the rod 54 so that the diaphragm piece 98 can ascend and descend. The diaphragm piece 98 is allows the diaphragm 12 to be disposed so that the diaphragm 12 can be pressed in the direction of the valve seat 13.

The valve seat 13 is formed of a resin material such as a fluorine resin such as, for example, PFA (copolymer of tetrafluoroethylene and perfluoro alkoxyethylene) to have a ring shape, and is mounted in an area closer to the valve chamber 99 so as to be able to seal the diaphragm 12.

The body 14 is fixed to the base 20 by allowing the male thread portion 29 and the female thread portion 94 to threadedly engage with each other in a state in which the diaphragm 12, the bonnet 97, and the diaphragm piece 98 are attached to the attaching portion 96. As a result, the fluid-controlled valve 10 is formed to be integrated with the actuator 11. After clamping of the body 14 and the base 20, the bonnet 97 is pressed in an area closer to the bottom surface of the connection 28 of the base 20. The diaphragm 12 is fixed to a predetermined place in the body 14 in a positioning state via the bonnet 97.

In the fluid-controlled valve 10 in the embodiment described above, the actuator 11 is a normally-closed actuator. However, the fluid-controlled valve of the present invention can be formed so that the actuator is a normally-open actuator, that is, so that the diaphragm is in a valve open state in a normal state (in a natural state), and the diaphragm is in a valve open state in the case of supplying compressed air.

In the fluid-controlled valve 10 described above, power is transmitted using the pistons 23 including two pistons which are the first piston 23a and the second piston 23b, and the springs 24 including two springs which are the first spring 24a and the second spring 24b. However, pistons 23 including three or more pistons, and springs 24 including three or more springs may be used. In such a case, the number of air inlets may also be increased, as appropriate.

Each O-ring is formed of the fluorine rubber as a material. The material can be changed as appropriate depending on, for example, adjustment of the slidability and sealing performance of the piston. Various rubber materials other than the fluorine rubber, and other materials can also be used.

It is desirable to use, for example, clean dry air as the compressed air supplied from the first and second air inlets 25a and 25b. However, a gas other than the clean dry air can also be used.

In the embodiment described above, the fluid-controlled valve 10 is described as a valve for ALD or ALE in a step of manufacturing a semiconductor. However, the fluid-controlled valve 10 can be used in various applications in a step of manufacturing a semiconductor and a step of manufacturing a panel, other than the ALD and the ALE. Furthermore, the fluid-controlled valve 10 can also be used in common applications except such fields.

Subsequently, the operation and action of the fluid-controlled valve of the present invention in the embodiment described above are described.

The fluid-controlled valve 10 of the present embodiment can be controlled in response to each of process of supplying material gas into a process chamber (not illustrated), purge in the body thereof or in piping (not illustrated), or maintenance in an airtightness test or the like.

In process, the opening and closing of the diaphragm 12 are controlled in a process mode described later. In the purge or the maintenance, the opening and closing of the diaphragm 12 are controlled in a maintenance mode described later. The process mode and the maintenance mode are designed so as to be able to be optionally changed in the case of controlling the fluid-controlled valve 10.

In the process mode and the maintenance mode, FIG. 1 illustrates the fully closed state of the fluid-controlled valve, FIG. 2 illustrates the full open state of the fluid-controlled valve, and FIG. 3 illustrates the valve open state of the fluid-controlled valve in the process mode.

FIG. 4 illustrates the opening and closing state of the diaphragm 12 of the fluid-controlled valve 10 in FIGS. 1 to 3. FIG. 4 also illustrates that a left valve is the fluid-controlled valve in the state of FIG. 1, a central valve is the fluid-controlled valve in the state of FIG. 2, and a right valve is the fluid-controlled valve in the state of FIG. 3 respectively. In FIG. 4, the chain double-dashed lines are lines drawn for comparing each of the positions of the bottom surface of (the shaft of) the first piston 23a and the bottom surface of (the shaft of the lower piston of) the second piston 23b.

In the case of operation of the actuator 11 in the fluid-controlled valve 10, the rod 54 and the diaphragm piece 98 are interlocked in the operation, and a thrust generated by the operation is transmitted to the diaphragm 12. As a result, the diaphragm 12 is brought into intimate contact with the valve seat 13 to be sealed to achieve a valve-closed state, or the diaphragm 12 is separated from the valve seat 13 to achieve the valve open state with a predetermined opening degree, whereby the flow of fluid can be controlled.

### <Maintenance Mode>

The maintenance mode is an operation system in purge of the fluid-controlled valve 10 or the interior of a pipe connected to the fluid-controlled valve 10, or in maintenance of, for example, various tests such as airtightness tests for the fluid-controlled valve 10. In the maintenance mode, the first piston 23a and the second piston 23b simultaneously ascend and descend, the full open state of the valve is achieved in the case of the ascending of the two pistons 23a and 23b, and the fully closed state of the valve is achieved in the case of the descending of the two pistons 23a and 23b.

In the maintenance mode, the supply of the compressed air from the first and second air inlets 25a and 25b is stopped in a normal state. In FIG. 1, the upper piston 60 is allowed to descend in the case 21 by the spring force of the second spring 24b, and the upper piston 60 further presses the lower piston 62 to allow the lower piston 62 to be in the state of also descending with respect to the base 20. Furthermore, the shaft 50 of the first piston 23a is pressed against the shaft 70 of the lower piston 62, whereby the first piston 23a is allowed to also descend with respect to the base 20.

The first piston 23a is allowed to descend in the base 20 by the spring force of the first spring 24a. In such a case, the second piston 23b and the first piston 23a simultaneously descend. As a result, the resultant force of the pressing force from an area closer to the second piston 23b, resulting from the elastic force of the second spring 24b described above, and the spring force of the first spring 24a acts on the first piston 23a, and a thrust resulting from the resultant force is applied from the rod 54 to the diaphragm 12 through the diaphragm piece 98 from above, to achieve a valve-closed state.

In such a case, the sum of the spring loads of the first spring 24a and the second spring 24b is set at a magnitude for sealing pressure gas supplied into the flow path 44 in the case of pressing the pressing diaphragm 12 against the valve seat 13 via the first piston 23a and the second piston 23b.

As a result, sufficient valve-closing sealing performance is exhibited, and sufficient sealing performance can be exhibited to reliably prevent leakage in a case in which not only material gas (process gas) having a low pressure of around 0.1 MPaG for controlling the flow rate for a process but also pressure gas having, for example, a higher pressure of around 0.7 MPaG than the pressure of the material gas in purge or maintenance is going to flow in the case of closing the valve.

Compressed air is supplied from both the first and second air inlets 25a and 25b in FIG. 2 in the case of achieving a full open state from the state of FIG. 1 in the maintenance mode.

In such a case, compressed air supplied from the second air inlet 25b flows from the penetrating flow path 68 of the upper piston 60 to the penetrating flow path 72 of the lower piston 62 in an area closer to the case 21, and is supplied to each of a first air chamber 81 between the upper piston 60 and the middle piston 61, and a second air chamber 82 between the lower piston 62 and the bottom surface side of the concave hole 33 of the case 21. Each of the upper piston 60 and the lower piston 62 is allowed to ascend in the case 21 by the pressure of the compressed air, and the operation thereof allows the whole second piston 23b to ascend while also allowing the middle piston 61 to slightly ascend.

As described above, the second piston 23b is allowed to have a segmented structure including the upper piston 60, the middle piston 61, and the lower piston 62, a structure in which compressed air is supplied to each of the first air chamber 81 and the second air chamber 82 is achieved by the segmented structure, and compressed air having a predetermined pressure is allowed to simultaneously act on the bottom surfaces of the disk portions 66 and 71 having predetermined areas of the upper and lower pistons 60 and 62. Therefore, the pistons can be allowed to efficiently ascend in comparison with the case of supplying compressed air having the same pressure to a piston having the same base area.

In an area closer to the base 20, compressed air supplied from the first air inlet 25a is supplied to the third air chamber 83 between the first piston 23a and the bottom surface of the concave hole 26 of the base 20. The first piston 23a is allowed to ascend in the base 20 by the pressure of the compressed air.

In such a case, the shaft 70 of the lower piston 62 is pressed against the shaft 50 of the first piston 23a, whereby the lower piston 62 is allowed to also ascend. As a result, the resultant force of a force resulting from compressed air from the first air inlet 25a and a force resulting from compressed air from the second air inlet 25b acts on the whole first and second pistons 23a and 23b, and the first and second pistons 23a and 23b are allowed to ascend against the spring forces of the first and second springs 24a and 24b by a thrust resulting from the resultant force.

The ascending of the first and second pistons 23a and 23b release the pressing force on the diaphragm 12 via the rod 54 and the diaphragm piece 98, whereby the diaphragm 12 is allowed to be separate from the valve seat 13 to achieve a valve open state while pushing up the diaphragm piece 98 and the rod 54 by the elastic force of the diaphragm 12 in a self-recover direction.

In the valve open state, pressure gas (compressed air) can be allowed to flow from the primary side flow path 91 to the secondary side flow path 92 in purge or maintenance in a maintenance mode.

In such cases, purge of the interiors of the body of the fluid-controlled valve 10 and the pipe at a high pressure of, for example, 0.7 MPaG or more is performed to reduce remaining process gas.

In the maintenance mode, it is not necessary to allow the first and second pistons 23a and 23b to repeatedly ascend and descend in a short time, and a state in which the first and second pistons 23a and 23b remain in the ascended positions, or a state in which the first and second pistons 23a and 23b remain in the descended positions is kept to perform the purge or the maintenance. As described above, the resultant force of the spring forces of the first and second springs 24a and 24b acts principally on the diaphragm 12 and the valve seat 13 in a static load manner, whereby an impulsive load on the diaphragm 12 and the valve seat 13 is prevented to prevent, for example, the deformation or breakage of the diaphragm 12 and the valve seat 13.

### <Process Mode>

The process mode is an operation system in the case of supplying material gas from the fluid-controlled valve 10 to a process chamber (not illustrated). In the process mode, only the first piston 23a can be allowed to ascend and descend in a state in which the second piston 23b ascends, and in a state in which the second piston 23b remains in the ascended position, the state of opening the valve is achieved in a case in which the first piston 23a ascends, and the state of closing the valve is achieved in a case in which the first piston 23a descends.

The valve open state in the process mode is a state similar to the case of the full open state of FIG. 2 in the maintenance mode described above. Compressed air is supplied from both the first and second air inlets 25a and 25b, to allow the first and second pistons 23a and 23b to ascend, and to allow the diaphragm 12 to be in a valve open state. In the operation of opening and closing the valve in the process mode, the first piston may be allowed to ascend and descend in a state in which the second piston 23b remains in the ascended position, as described above. In other words, a smooth shift to the process mode is enabled in a case in which the first piston 23a is operated from the full open state of the maintenance mode.

Compressed air to an area closer to the first air inlet 25a is stopped while maintaining a state in which compressed air is supplied from the second air inlet 25b in FIG. 3 in the case of achieving a valve-closed state from the state of FIG. 2 in the process mode.

In such a case, in an area closer to the case 21, compressed air is supplied to each of the first and second air chambers 81 and 82 to achieve a state in which the whole second piston 23b is allowed to remain in the ascended position in the case 21 by the pressure of the compressed air, like the case of the full open state in the maintenance mode.

In an area closer to the base 20, stopping of compressed air to an area closer to the first air inlet 25a allows the first piston 23a to descend by the spring force of the first spring 24a. In such a case, a pressing force from an area closer to the second piston 23b by the second spring 24b is not applied to the first piston 23a, and a valve-closed state is achieved in a state in which only a thrust resulting from the first spring 24a is applied from the rod 54 to the diaphragm 12 via the diaphragm piece 98.

In such a case, the spring load of the second spring 24b is set to be greater than the spring load of the first spring 24a, and the spring force of first spring 24a less than that of the second spring 24b is applied to an area closer to the first piston 23a. Therefore, the thrust of first piston 23a can be reduced to a low level to greatly decrease a pressing force to an area closer to the valve seat 13 in the valve-closed state in the process mode in comparison with the maintenance mode. Therefore, a load on the diaphragm 12 or the valve seat 13 can be reduced to a low level, to prevent, for example, the deformation or breakage of the diaphragm 12 and the valve seat 13, even in a case in which the first piston 23a is allowed to repeatedly ascend and descend to control the amount of supplied material gas having a low pressure in the process mode.

The spring load of the first spring 24a is set at a magnitude for being capable of sealing material gas supplied into the flow path 44 in the case of pressing the diaphragm 12 against valve seat 13 via the first piston 23a in a state in which the second piston 23b remains in the ascended position. As a result, the material gas is reliably sealed by a pressing force to the valve seat 13 of the first piston 23a resulting from the first spring 24a in a valve-closed state. Specifically, the pressure of the material gas is 0.1 MPaG, which is lower than the maximum allowable working pressure, which is 0.7 MPaG, of the pressure gas used in the maintenance mode. Therefore, sufficient sealing performance is exhibited by the spring force of the first spring 24a, to reliably prevent leakage.

In a case in which the first piston 23a ascends and descends in a state in which the second piston 23b remains in the ascended position, the gap 45 is disposed between the facing surfaces of the second piston 23b and the first piston 23a that ascends, that is, between the facing end surfaces of the shafts 50 and 70, and therefore, in a case in which the first piston 23a ascends in the process mode, the first piston 23a is prevented from coming into contact with the second piston 23b in the ascending state, whereby the first piston 23a is smoothly operated.

The control of high-speed opening and closing of the diaphragm 12 is required in the case of supplying the material gas to the process chamber in the process mode. For the requirement, the valve is opened and closed only by the first piston 23a in the narrow volume of the small cylinder chamber Cs. In such a case, in the operation of opening the valve, the volume of the third air chamber 83 of the small cylinder chamber Cs is allowed to be greatly smaller than that of the whole cylinder, that is, the total of the volumes of the first to third air chambers in the small cylinder chamber Cs and the large cylinder chamber Cb, whereby the third air chamber 83 can be filled with a small amount of supplied compressed air in a short time to allow the first piston 23a to ascend to achieve a valve open state. In the operation of closing the valve, the first piston 23a can be allowed to reliably descend by the first spring 24a of which the spring load is smaller than that of the second spring 24b, to achieve a valve-closed state while increasing a response speed.

In such a case, an impulsive dynamic load is allowed to repeatedly act on the diaphragm 12 and the valve seat 13 by the high-speed opening and closing operation. However, as described above, the first piston 23a is allowed to ascend and descend by the first spring 24a of which the spring load is smaller than that of the second spring 24b, and a force principally generated only by the first piston 23a acts on the diaphragm 12 and the valve seat 13 in closing of the valve. Therefore, a load applied to the diaphragm 12 and the valve seat 13 can be reduced to a low level, the transfer of the valve seat 13 to the diaphragm 12 can be reduced, and the deformation and breakage of the diaphragm 12 and the valve seat 13 can be prevented, in comparison with a common valve for controlling fluid (not illustrated) having a structure in which the pressing force of a piston does not vary during maintenance or during process.

A comparison is made between the maintenance mode and the process mode described above. In the maintenance mode shown in FIG. 4, the state of the left valve (state of FIG. 1) is in full closing, and the state of the central valve (state of FIG. 2) is in full opening. The state of the left valve (state of FIG. 1) is achieved in full closing, and the state of the central valve (state of FIG. 2) is achieved in full opening, with regard to the state of opening and closing the valve, in the maintenance mode in FIG. 4.

In comparison with the case of the central valve in the full open state, the second piston 23b becomes in the state of descending by the stroke Y2 in the case of the left valve in the fully closed state, whereby the first piston 23a becomes in the state of descending by the stroke Y1.

In closing of the valve, a force in the descending direction from the second piston 23b is also applied in a case in which the first piston 23a descends, and therefore, the force as the sum of the spring loads of the first spring 24a and the second spring 24b acts on the first piston 23a, and a sealing force in the closing of the valve is increased.

In the process mode, the state of the right valve (state of FIG. 3) is achieved in closing of the valve, and the state of the central valve (state of FIG. 2) is achieved in full opening, like the fully closed state in the maintenance mode.

In comparison with the case of the state of opening the right valve, the state of descending of the second piston 23b by the stroke Y2 is achieved, and the first piston 23a is at the same descending position as that in the case of the state of opening the right valve, in the case of the state of closing the left valve. In such a case, a force is prevented from being applied from an area closer to the second piston 23b to an area closer to the first piston 23a because the gap 45 is disposed between the second piston 23b and the first piston 23a.

Therefore, only a force resulting from the spring load of the first spring 24a acts on the first piston 23a in a case in which the first piston 23a descends in closing of the valve, and a sealing force in the closing of the valve is lower than that in the full closing in the maintenance mode. In such a case, material gas is reliably sealed because the spring load of the first spring 24a is set at a magnitude for sealing the material gas supplied into the flow path 44.

In the first piston 23a, the descending operation by the first spring 24a and the ascending operation by compressed air from the first air inlet 25a enable the response speed of opening and closing of the valve in the process mode to be decreased to about ¼ of that in the maintenance mode.

In the process mode, a reduction in a load (surface pressure) received by the surface of the valve seat 13 in comparison with the maintenance mode causes a reduction in the residual stress of the valve seat 13, the deformation thereof is substantially in an elastic deformation region, and therefore, the deformation and surface roughness of the valve seat 13 are inhibited.

In such a case, the surface pressure against the valve seat 13 in closing of the valve can be reduced to not more than about ⅓ of that in the maintenance mode, and residual stress does not substantially remain.

As a result, a variation in Cv value can be reduced to a low level to allow the stabilization thereof.

In such a case, for example, a maximum stress of 5.33 MPa is generated, and a maximum residual stress of 0.001 MPa is generated on the valve seat 13 in the closing of the valve. In contrast, in the case of a common fluid-controlled valve integrated with a piston under the same conditions, a maximum stress of 10.24 MPa is generated, and a maximum residual stress of 2.48 MPa is generated on a valve seat in closing of the valve. As described above, the maximum stress and maximum residual stress of the fluid-controlled valve 10 of the present embodiment can be greatly decreased in comparison with such a fluid-controlled valve integrated with a piston.

In the case of the maintenance mode described above, compressed air is discharged from the first and second air inlets 25a and 25b of the actuator 11 in the operation of closing the valve, a thrust for allowing the first piston 23a and the second piston 23b to ascend is generated in the operation of opening the valve, and therefore, compressed air supplied from the first and second air inlets 25a and 25b is required.

In contrast, in the case of the process mode, compressed air is discharged from the first air inlet 25a in a state in which compressed air is supplied to the second air inlet 25b in the operation of closing the valve, a thrust for allowing the first piston 23a to ascend is generated from the state in the operation of opening the valve, and therefore, compressed air supplied from the first air inlet 25a is required.

In other words, pistons operated at the minimum are three pistons in total of the first piston 23a, the upper piston 60 in the second piston 23b, and the lower piston 62 in the maintenance mode. In contrast, in the process mode, such a piston may be only one first piston 23a. The intake and exhaust of compressed air only from and to the first air inlet 25a are acceptable according to each cycle in opening and closing of the valve. Therefore, the amount of consumed compressed air used can be reduced to reduce consumed energy in comparison with the maintenance mode. In such a case, the outer diameter of the first piston 23a is smaller than the outer diameter of the second piston 23b, and the volume in the cylinder is also small. Therefore, the amount of necessary compressed air can be reduced to not more than ⅕.

Piston operation in the process mode is enabled by the small compressed air, and therefore, a piston diameter can also be reduced.

In the maintenance mode, in both cases of the operation of opening the valve and the operation of closing the valve, the upper piston 60 and the lower piston 62 of the first piston 23a and the second piston 23b are allowed to principally ascend and descend by compressed air from the first and second air inlets 25a and 25b, or the first and second springs 24a and 24b, and therefore, the nine O-rings 52, 53, and 67 attached thereto slide in the actuator 11.

In contrast, in the case of the process mode, in both cases of the operation of opening the valve and the operation of closing the valve, only the lower piston 62 is allowed to ascend and descend by compressed air from the first air inlet 25a, or the first spring 24a, and therefore, the three O-rings consisting of the O-rings 52 and the O-ring 67 attached to the lower piston 62 slide in the actuator.

Based on the above, the sliding friction caused by the O-rings in the piston operation in the process mode is lower than that in the maintenance mode, and the wear of each O-ring in the process mode can also be suppressed in comparison with the maintenance mode. In such a case, the number of the sliding O-rings is small, and the outer diameters thereof are also small. Therefore, the sliding friction can be reduced to not more than ⅔.

In both cases of the maintenance mode and the process mode, the first and second pistons 23a and 23b ascend in full open, whereby the diaphragm 12 is greatly deformed to widely form an opening flow path between the primary side flow path 91 and the secondary side flow path 92. Therefore, each of the pressure gas and the material gas can be allowed to flow at the predetermined flow rate, to quickly enable a process step, or purge or a maintenance step for an airtightness test or the like in a short time.

In such a case, the stroke Y1 between the full open state and the full close state is necessary, and the ascending stroke in a case in which the diaphragm piece 98 moves is generally equal to the stroke Y1. The stroke Y1 of which the distance is longer than that of the stroke Y2 enables the diaphragm 12 to be greatly deformed in the full open state, whereby a wide opening flow path between the primary side flow path 91 and the secondary side flow path 92 to be ensured.

As described above, in accordance with the fluid-controlled valve in above-described embodiment of the present invention, the time of opening and closing the valve in a state in which a stress or load on the diaphragm 12 or the valve seat 13 is reduced in the case of the process mode can be further shortened in comparison with the maintenance mode by enabling the pressing force of each piston 23 against the diaphragm 12 in closing of the valve (fully closed), that is, the thrust of the actuator 11 in the process mode and the maintenance mode of which the working pressures are different, to vary. As a result, the deterioration of sealing performance due to long-term use or the like can be prevented to improve durability, and the stability of a Cv value can be enhanced to control the flow rate with high accuracy.

For example, in a case in which the material gas to the fluid-controlled valve 10 is nitrogen gas, and fluid control of the material gas is performed under conditions of a temperature of 250° C. and a pressure of 0.1 MPa, 25,000,000 operations of opening and closing can be tolerated while reducing a variation in Cv value to 1.2±3%.

In such a case, opening and closing of the valve is controlled by reciprocatingly operating only the first piston 23a which is resiliently biased by the first spring 24a of which the spring load is smaller than that of the second spring 24b in the process mode. Therefore, in addition to, for example, the above-described maintenance of seal performance in the closing of the valve, a decrease in load applied to compressed air for driving the piston 23 is also enabled, the high-speed operation of ascending and descending of the pistons 23 is enabled, and, in particular, provision of the fluid-controlled valve suitable for ALD and ALE is enabled.

The embodiment of the present disclosure is described above. However, the present disclosure is not limited to the embodiment described above but can be subjected to various modifications without departing from the gist of the present disclosure.

What is claimed is:

1. A fluid-controlled valve, wherein pistons are mounted in an actuator via springs, the pistons allow a valve disk to contact with and separate from a valve seat to open and close a flow path by compressed air from air inlets or spring forces of the springs, the pistons are separately formed as a plurality of piston members, the separate pistons are arranged in a series state with respect to the valve seat in a spring state via the plurality of springs having different spring loads, the corresponding air inlets through which the compressed air that operates the corresponding separate pistons in directions opposite to spring directions of the springs is supplied are formed in the actuator, the corresponding separate pistons are disposed so that the compressed air from the corresponding air inlets or the spring forces of the corresponding springs cause the pistons to separately and independently ascend and descend in predetermined strokes in the actuator, and the valve disk is disposed so as to be able to seal the flow path by different sealing forces depending on descending states of the corresponding separate pistons formed as the plurality of piston members.

2. The fluid-controlled valve according to claim 1, wherein the corresponding separate pistons comprise a first piston arranged in a primary side at a position in a vicinity of the valve disk and a second piston disposed on the secondary side farther from the valve disk than the first piston, the first piston and the second piston are disposed so as to be able to simultaneously ascend and descend, or the first piston is disposed so as to be able to ascend and descend in a state in which the second piston ascends.

3. The fluid-controlled valve according to claim 2, wherein a first spring is mounted in an area closer to the first piston, a second spring is mounted in an area closer to the second piston, and a spring load of the second spring is set to be greater than a spring load of the first spring.

4. The fluid-controlled valve according to claim 3, wherein the spring load of the first spring is set at a magnitude for sealing material gas for a semiconductor manufacturing step, supplied into the flow path in a case in which the valve disk is pressed against the valve seat via the first piston in a state in which the second piston ascends.

5. The fluid-controlled valve according to claim 3, wherein a sum of the spring loads of the first spring and the second spring is set at a magnitude for sealing pressure gas for purge or maintenance, supplied into the flow path in a case in which the valve disk is pressed against the valve seat via the first piston and the second piston.

6. The fluid-controlled valve according to claim 1, wherein the corresponding springs are mounted in a spring state in a direction in which the corresponding separate pistons are allowed to descend to close the valve disk, and the corresponding air inlets are formed in the actuator so that compressed air can be supplied in a direction in which the corresponding separate pistons are allowed to ascend to open the valve disk.

7. The fluid-controlled valve according to claim 2, wherein a gap is disposed between facing surfaces of the second piston and the first piston that ascends in a case in which the first piston ascends and descends in a state in which the second piston ascends.
